(19) United States
(12) Patent Application Publication
(10) Pub. No.: US 2011/0173285 A1
(43) Pub. Date: Jul. 14, 2011

(54) CHANNEL STATUS MESSAGE FOR VIRTUAL NIC

(76) Inventors: Daniel N. CRIPE, Round Rock, TX (US); Charles L. Hudson, Round Rock, TX (US); Doron Chosnek, Houston, TX (US); David J. Koenen, Round Rock, TX (US)

(21) Appl. No.: 12/687,642

(22) Filed: Jan. 14, 2010

(51) Int. Cl. G06F 15/16

(52) U.S. Cl. 709/207; 709/250

(57) ABSTRACT

A network device comprises a processor and storage coupled to the processor. The storage contains firmware that, when executed by the processor, causes the processor to implement a plurality of virtual devices. Each virtual device is configured to receive packets in a channel unique to such virtual device. The channels of the plurality of virtual devices are implemented on a single communication link. The network device is configured to receive a channel status message that is indicative of status of a channel corresponding to that message.

### BACKGROUND

Computers (e.g., servers) may include a network interface controller (NIC) that communicates with a switch port over a communication link. For reliability management, a link status signal may be asserted to the NIC by the switch upon loss of communication on the communication link. The link status signal informs the NIC that the communication link is non-operational so that the computer and NIC cease trying to communicate over the link.

In some systems, a single NIC can be configured as multiple virtual NICs communicating over channels implemented on a common link. In such systems, the ability of the switch to communicate with individual virtual NIC channels is impaired with a link status signal which indicates status of the entire link and not an individual virtual NIC channel.

### BRIEF DESCRIPTION OF THE DRAWINGS

For a detailed description of exemplary embodiments of the invention, reference will now be made to the accompanying drawings in which:

FIG. 1 shows a system in accordance with various embodiments;

FIG. 2 shows an alternative representation of a system in accordance with various embodiments;

FIG. 3 illustrates a channel status message in accordance with various embodiments; and

FIG. 4 shows a method in accordance with various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. All software and firmware described herein comprise instructions that are executable by a processor.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

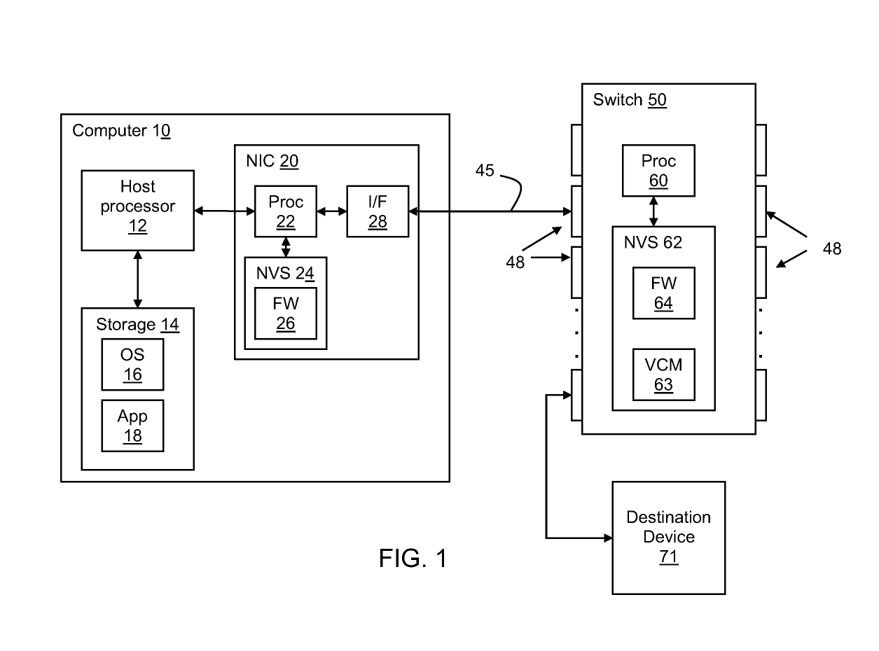

In accordance with the embodiment of FIG. 1, an electronic device 10 such as a computer (e.g., a server) is coupled to a network switch 50 via a communication link 45. Device 10 will be referred to herein as a computer but could be other than a computer in other embodiments. In some embodiments, the communication link 45 comprises one or more electrical conductors over which communications between the computer 10 and switch 50 can be transmitted. A destination device 71 is also shown coupled to the switch 50. The destination device 71 may comprise another computer or other type of computing device such as a storage device, printer, etc. One or more other switches 50 can be included in the network as well as various routers, hubs and the like. Various end nodes such as computer 10 and destination device 71 are provided. In general, the end nodes (e.g., computer 10, destination device 71) send packets back and forth to each other through the fabric of switches (e.g., switch 50), routers, etc. Each of the computer 10 and switch 50 comprise network-enabled devices (or simply “network devices”).

The computer 10 comprises one or more host processors 12 coupled to storage 14 and to a network interface controller (NIC) 20. The storage 14 comprises volatile memory (e.g., random access memory), non-volatile storage (e.g., hard disk drive, Flash storage, etc.), or combinations thereof. The storage 14 comprises an operating system 16 and one or more applications 18 that are executed by the host processor 10.

In various embodiments, the NIC 20 comprises a processor 22 coupled to non-volatile storage (NVS) 24 and an interface 28. The NVS 24 comprises, for example, Flash memory or read-only memory (ROM). The NVS 24 stores firmware 26 which is executed by processor 22 to provide some or all of the functionality described herein attributed to the NIC 20. The interface 28 provides electrical connectivity to the communication link 45. The interface 28 may comprise electrical drivers, receivers, filters, and the like.

The network switch 50 comprises multiple ports 48 to which various computers 10, other switches, or other types of network devices (e.g., routers) can be connected via, for example, a communication link 45. The switch 50 further comprises a processor 60 coupled to a non-volatile storage 62 which contains firmware 64 executable by processor 60.

In accordance various embodiments, the NIC 20 may be configured as multiple virtual NICs. That is, the NIC 20 can be programmed to have a different address for each such virtual NIC (VNIC) and track communications between each virtual NIC and a destination device (e.g., destination device 71) to which such virtual NIC communicates as if physically separate NICs were present in computer 10. To the operating system 16, the virtual NICs operate and function as separate physical NIC devices. In some embodiments, the virtualization of the NICs is performed by the NIC's firmware 26 executing on processor 22.

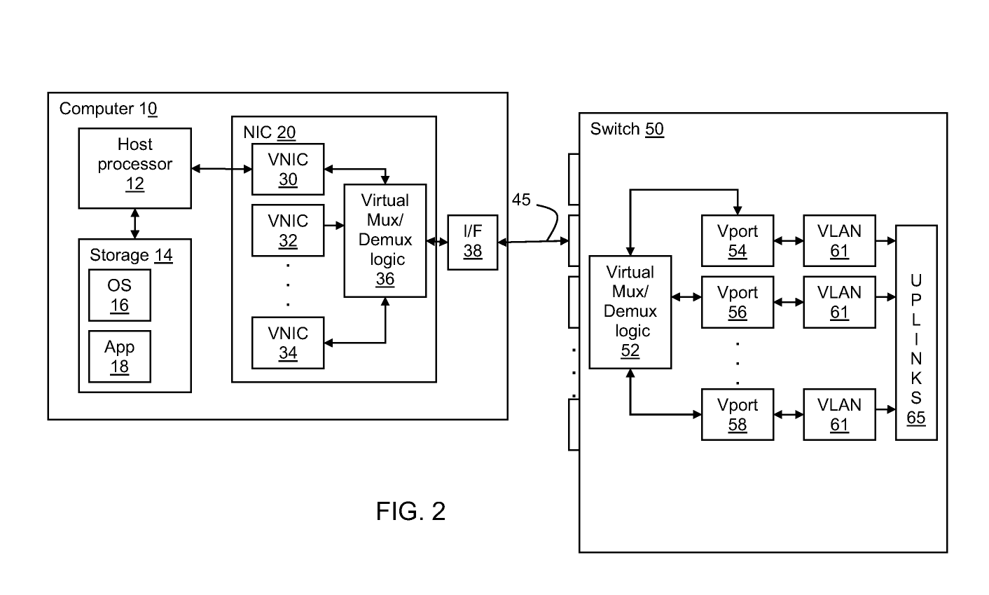

FIG. 2 illustrates a partial functional diagram of the hardware diagram of FIG. 1. As shown in FIG. 2, the NIC 20 is represented functionally as multiple NICs 30, 32, and 34, which may be virtual NICs in at least some embodiments. Three virtual NICs 30-34 are shown in FIG. 2, but other numbers of virtual NICs are possible in other embodiments.

In embodiments in which the NIC 20 is configured as multiple virtual NICs 32-34, the NIC 20 also implements a virtual multiplexer/de-multiplexer 36. The virtual multiplexer/de-multiplexer 36 may be implemented in hardware or in firmware 26 executing on processor 22. The virtual multiplexer/de-multiplexer 36 receives packets from the various virtual NICs 30-34, multiplexes them together, and provides the combined multiplexed packets to the interface 38 for transmission on the communication link 45 to switch 50. As such, the multiplexed packets from the various virtual NICs 30-34 are provided on a common conductor within the communication link 45.

Each virtual NIC 30-34 includes, generates, or is otherwise provided with a virtual local area network (VLAN) tag that each such virtual NIC associates with a given packet. The VLAN tag of one virtual NIC is different than the VLAN tag of another virtual NIC. The VLAN tags enable the packets to be associated with their respective virtual NICs 30-34. The VLAN tags permit the packets from the various virtual NICS 30-34 to be multiplexed together on a common conductor and then to be de-multiplexed and thus recovered by the receiving switch 50.

Associated with a port 48 to which NIC 20 couples via communication link 45, the switch 50 comprises multiplexer/de-multiplexer logic 52 and a plurality of virtual ports 54-58. The virtual multiplexer/de-multiplexer logic 52 and the various virtual ports 54-58 are implemented, in some embodiments, by the processor 60 executing the firmware 64. Each virtual port 54-58 is associated with one or more VLANs 61 which, in turn, provide connectivity to one or more uplinks 65.

As required by the operating system 16 or application(s) 18, the host processor 12 may need to send a packet of information through a network to a destination device (e.g., destination device 71, FIG. 1). The host processor 12 provides the packet to one of the virtual NICs 30-34 to have transmitted on the communication link 45. The targeted virtual NIC 30-34 includes the appropriate VLAN tag with the packet and provides the tagged packet to the multiplexer/de-multiplexer 36 which multiplexes the tagged packet along with, if present, other tagged packets from the other virtual NICs. The multiplexed tagged packets are transmitted over the communication link 45 to the switch 50. The switch's multiplexer/de-multiplexer 52 uses the VLAN tags in the packets to de-multiplex the packets and provide the de-multiplexed packets to the correct virtual port 54-58.

For packets from switch 50 to computer 10, the switch's multiplexer/de-multiplexer 52 receives packets with VLAN tags from its respective virtual ports 54-58, multiplexes such packets together, and transmits the multiplexed packets over communication link 45 to the interface 38 of the computer 10. The computer's multiplexer/de-multiplexer 36 receives the multiplexed packets from the switch 50 via interface 38 and de-multiplexes the packets based on the packets' VLAN tags included with the packets. The multiplexer/de-multiplexer 36 thus separates the various packets based on the VLAN tags and provides the packets to the appropriate virtual NIC 30-34.

Once a virtual NIC 30-34 receives a packet from the multiplexer/de-multiplexer 36, the virtual NIC removes the VLAN tag and provides the packet to the operating system 16 or an application executed by the host processor 12. In other embodiments, the multiplexer/de-multiplexer 36 removes the virtual tag from the packet. In yet other embodiments, the VLAN tag is not removed the packet.

In this way, the host processor 12 (via the operating system 16 or an application 18) is able to send packets to and receive packets from the network switch 50 via one of the virtual NICs 30-34 and a corresponding virtual node 54-58. The communication flow between a virtual NIC 30-34 and a corresponding virtual node 54-58 is referred to as a “channel.” Each virtual NIC 30-34 thus has its own channel for sending/receiving packets over a common conductor on communication link 45. At least some, and perhaps all, of the channels of the various virtual NICs 30-34 are provided on a common conductor. The use of VLAN tags enables the multiplexers/de-multiplexers 36 and 52 to correctly process and route each packet between the virtual NICs 30-34 and virtual ports 54-58 over individual channels provided on a common conductor on communication link 45. Identifiers besides VLAN tags can be used as well.

In some embodiments, an application 63, such as a Virtual Connect Manager (VCM), is executed on the switch 50 by its processor 60 to coordinate the assignment of a common VLAN tag for a particular channel and the virtual NIC 30-34 and corresponding virtual port 54-58 pertaining to that channel. The VCM application 63 generates the VLAN identifier for a given channel and manages the configuration of the NIC 20 and the switch 50 so that both NIC 20 and switch 50 agree as to the VLAN identifier for a given channel. The control of the NIC 20 by the VCM application 63 executing on the switch 50 is accomplished through Command Line Protocol (CLP—part of the SMASH DMTF standards) commands that are executed for the NIC 20 during initialization of the computer (e.g., during Power-On Self Test). Such CLP commands are executed on the host processor 12 of computer 10.

It is possible, however, that one or more of the channels but not all become non-operational. For example, a virtual port 54-58 on the switch 50 may be non-operational thereby rendering the channel pertaining to the non-operational virtual port as itself non-operational. For whatever reason a channel becomes non-operational, the virtual NIC 30-34 corresponding to that non-operational channel eventually may time-out thereby detecting the failure. That is, each virtual NIC 30-34 starts a timer function upon sending out a packet to the switch 50. If no response to that packet is received before the timer function expires, the virtual NIC determines that the channel or the entire communication link 45 is down (non-operational).

In accordance with various embodiments, a particular virtual port may become non-operational. Such a change in operational status may be due to any of a variety of conditions. An example includes a change in the status of another physical port 48 (e.g., “uplinks”—connections from the switch 50 to the network at-large, “stacking links”—connections to other switches which coordinate the behavior of the virtual port, etc.). If all of the uplinks 65 for a VLAN 54-58 lose communication, the affected VLAN informs the corresponding VPORT 54-58 of the loss of uplink communication.

In accordance with various embodiments, the switch's multiplexer/de-multiplexer 52 may determine that a particular channel has become non-operational, for example, by detecting a change in status of communication through another physical port as explained above. Once the multiplexer/de-multiplexer 52 detects a failure of the virtual port, the multiplexer/de-multiplexer 52 transmits an in-band (i.e., over the same conductor that carries the multiplexed packets) channel status message to virtual NIC 30-34 corresponding to the failed virtual port. The channel status message identifies the channel to which the message pertains and includes the status of the channel. Examples of such status include “channel operational” and “channel non-operational.” The channel status message includes the VLAN tag (or other identifying attribute) of the channel to which the status pertains. In some embodiments, each virtual NIC 30-34 may detect a failure of its channel and generate and transmit a channel status message to the switch 50 (essentially the mirror operation from that described above from switch to NIC). Each of the virtual NICs 30-34 and virtual ports 54-58 are also referred to as “virtual devices.”

The multiplexer/de-multiplexer 36 receives the status message and forwards the message to the virtual NIC 30-34 having the same VLAN tag as the VLAN tag in the status message and thus as the corresponding virtual port 54-58. The virtual NIC receives the status message and may determine, based on the message's contents, that that virtual NIC's channel has become non-operational. The virtual NIC 30-34, receiving such a message, may react in any suitable manner. For example, the virtual NIC 30-34 may inform the operating system 16 or application 18 that the channel has become non-operational. As a result, the operating system 16 or application may choose to re-route packets via a different virtual NIC 30-34.

In accordance with some embodiments, the channel status message alerts the virtual NIC of a non-operational or failed channel before the time-out feature (if present) of the virtual NIC would have detected the failure.

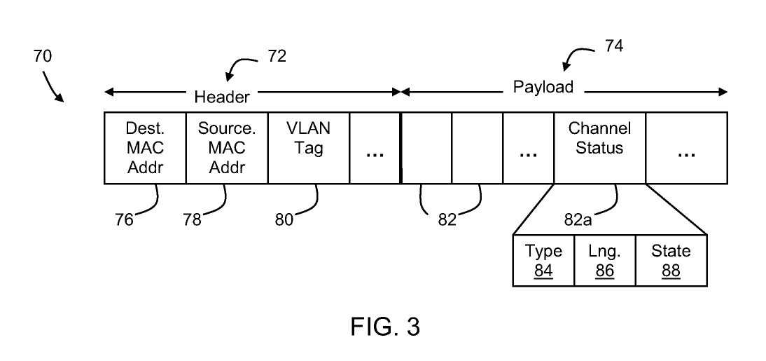

FIG. 3 illustrates an embodiment of an illustrative channel status message 70. The channel status message 70 of the embodiment of FIG. 3 includes a header 72 and a payload 74. The header 72 includes a media access control (MAC) destination address 76, a MAC source address 78, a VLAN tag 80, and other fields of information as desired. The VLAN tag 80 corresponds to the VLAN tag of the channel to which the channel status message pertains. The payload 74 includes one or more type/length/value (TLV) portions 82. Each TLV may be dedicated for a different purpose.

At least one of the TLVs 82 (e.g., TLV 82a) is dedicated for the purpose of communicating the status of the channel. In accordance with at least some embodiments, the channel status TLV 82a comprises three fields 84, 86, and 88. Each field may comprise a single octet (byte) but may be of different sizes in other embodiments. Field 84 indicates TLV type and as such indicates that the TLV 82a provides channel status. Field 86 indicates the length of the TLV's data which is provided in field 88. If data field 88 is a single octet than field 86 has a length of 1 octet. Field 88 provides the actual status of the channel as well as an identifier of such channel. In some embodiments, field 88 is encoded as “0” to indicate the channel is non-operational (down) and as a “1” to indicate that the channel is operational (up).

If desired, the TLV 82a may also indicate (e.g., in data field 88) additional characteristics of a channel such as speed, quality of service, flow control, and an identifier of the channel (generally the same as VLAN tag 80). In other embodiments, a separate TLV 82 is used for one or more of channel status, speed, quality of service, and channel identifier.

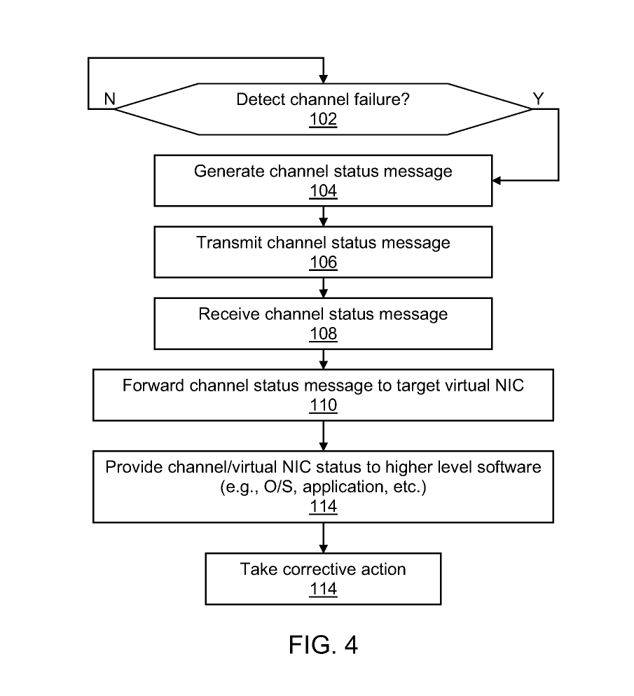

FIG. 4 illustrates a method 100 in accordance with various embodiments. The actions depicted in FIG. 4 may be performed in the order shown or in a different order. Further, two or more of the actions may be performed in parallel.

At 102, the method comprises determining whether a channel has failed. In some embodiments, the multiplexer/de-multiplexer 52 makes this determination as explained above. If a failure of a channel is detected by the multiplexer/de-multiplexer 52 (or the multiplexer/de-multiplexer 52 is otherwise informed of the channel failure), the multiplexer/de-multiplexer 52 generates (at 104) a channel status message indicating that the channel has become non-operational. At 106, the multiplexer/de-multiplexer 52 transmits the channel status message across the communication link 45 to the multiplexer/de-multiplexer 36 (via the interface 38). The multiplexer/de-multiplexer 36 receives the channel status message at 108.

At 110, the multiplexer/de-multiplexer 36 forwards the channel status message to the relevant virtual NIC 30-34 (i.e., the virtual NIC corresponding to the channel whose status has changed). That virtual NIC 30-34 provides the status to higher level software such as the operating system 16 or an application. Such higher level software takes corrective action at 112, such as re-routing future communications through a different virtual NIC 30-34.

After a channel has become non-operational and the channel status message has been communicated from the switch 50 to the multiplexer/de-multiplexer 36, the channel later may become operational again. For example, a software patch may be applied, a correction to some software or hardware configuration in the network may be made, or the virtual port may otherwise become operational. As such, the switch's multiplexer/de-multiplexer 52 may send another channel status message to reflect a new channel status (operational). The multiplexer/de-multiplexer 36 may receive the new channel status message and forward the message directly to the operating system 16, application, or other logical entity to inform the higher level software that a particular NIC (virtual NIC) that was previously indicated to be non-operational is again operational.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A network device, comprising:
a processor; and
storage coupled to said processor and containing instructions that, when executed by the processor, causes the processor to implement a plurality of virtual devices, each virtual device configured to receive packets in a channel unique to such virtual device, wherein channels of the plurality of virtual devices are implemented on a single communication link;
wherein said network device is configured to receive a channel status message that is indicative of status of a channel corresponding to that message.

2. The network device of claim 1 wherein said virtual device comprises at least one of a network interface controller (NIC) and a switch.

3. The network device of claim 1 wherein said processor reports said status from a channel status message to an operating system executed by said host processor.

4. The network device of claim 1 wherein the network device also is configured to receive a link status signal associated with said single communication link.

5. The network device of claim 1 wherein each channel status message also is indicative of at least one of speed, quality of service, and channel identifier.

6. A system, comprising:
a host processor; and
a network interface controller (NIC) coupled to said host processor and configured as a plurality of virtual NICs, each virtual NIC configured to receive packets on a channel unique to such virtual NIC, wherein at least some of the virtual NIC channels are provided on a common conductor;
wherein said NIC is configured to receive channel status messages, each channel status message indicative of status of a channel corresponding to that message.

7. The system of claim 6 wherein said NIC reports said status from a channel status message to an operating system executed by said host processor.

8. The system of claim 6 wherein said NIC also is configured to receive a link status signal indicative of status of said common conductor.

9. The system of claim 6 wherein each channel status message also is indicative of at least one of speed, quality of service, and channel identifier.

10. A method, comprising:
generating, by a network-enabled device, a channel status message for a particular communication channel of a plurality of channels implemented on a common conductor; and
transmitting said channel status message across said common conductor.

11. The method of claim 10 further comprising receiving said channel status message by a virtual NIC, said virtual NIC corresponding to the particular communication channel to which the channel status message pertains.

12. The method of claim 11 further comprising indicating the channel status to an operating system or an application.

13. The method of claim 10 wherein said channel status message indicates whether the particular communication channel is operational or not operational.

14. The method of claim 10 wherein said network-enable device comprises at least one of a network interface controller (NIC) and a switch.
